(19) United States
(12) Patent Application Publication
(10) Pub. No.: US 2013/0029198 A1
(43) Pub. Date: Jan. 31, 2013

(54) BATTERY UNIT AND POWER SUPPLY DEVICE

(71) Applicant: Toru Suzuki, Kanagawa (JP)

(72) Inventor: Toru Suzuki, Kanagawa (JP)

(73) Assignee: NEC ENERGY DEVICES, LTD., Kanagawa (JP)

(21) Appl. No.: 13/640,577

(22) PCT Filed: May 16, 2011
(86) PCT No.: PCT/JP2011/061141

§ 371 Date: Oct. 11, 2012

(30) Foreign Application Priority Data
May 19, 2010 (JP) 2010-115234

(51) Int. Cl. H01M 2/10; H01M 2/12

(52) U.S. Cl. 429/82

(57) ABSTRACT

Disclosed is a battery unit that includes: a plurality of laminate batteries (32) electrically connected with each other; and tray (33) on which the plurality of laminate batteries (32) is mounted and which is stackable on another tray (33) on which another plurality of laminate batteries (32) is mounted. On the respective outer peripheral portions of the plurality of laminate batteries (32), there are formed gas discharge sections (35) that respectively release pressures generated in the plurality of laminate batteries (32) to the outside. The plurality of laminate batteries (32) is disposed such that gas discharge sections (35) are adjacent to the outer peripheral portion of tray (33).

### TECHNICAL FIELD

The present invention relates to a battery unit that includes a plurality of laminate batteries electrically connected with each other, and a power supply device that includes the battery unit.

### BACKGROUND ART

In recent years, in view of environmental problems, attention has been focused on clean energy acquired from wind power generation or solar power generation, which can be put to household use of a detached house or industrial use such as a transport device or a construction device. However, clean energy has a problem in which there is a amount of fluctuation in the output depending upon the situations. For example, energy that is generated from solar power is acquired when the sun is out but cannot be acquired at night when the sun has set.

To stabilize the output of clean energy, a technology for temporarily storing the clean energy is used. For example, energy from sunlight stored in a battery can be used even at night after the sun has set. As the battery for storing such clean energy, a lead storage battery is generally used. However, the lead storage battery is generally large, and has a drawback of low energy density.

In place of the lead storage battery, a NAS battery (sodium-sulfur battery) can be used. The NAS battery is more compact and higher in energy density than the lead storage battery. However, in the case of the NAS battery, the operating temperature range is high, about 300° C., and thus large incidental facilities including a heater for heating the battery to operate are necessary. Further, since the NAS battery must be heated to the operating temperature range to properly operate, it takes time to operate the battery.

Recently, attention has focused on lithium ion secondary batteries as an alternative to NAS batteries. The lithium ion secondary battery can operate at a normal temperature, and has higher energy density. A lithium ion secondary battery has a high response speed due to its low impedance.

As lithium ion secondary batteries, there are a cylindrical or flat-plate square battery having a battery element included in a can-shaped container, and a laminate battery having a battery element included in a flexible film. The laminate battery generally has a flat-plate shape, and a positive electrode and a negative electrode are drawn out from the flexible film.

Patent Literature 1 describes a power supply device to which the laminate battery is applied. In the power supply device described in Patent Literature 1, a plurality of laminate batteries is horizontally and vertically arranged. In this power supply device, each laminate battery is housed in a casing.

### CITATION LIST

Patent Literature 1: JP3971684 B2

### SUMMARY OF INVENTION

### Problems to be Solved by Invention

In the power supply device described in Patent Literature 1, when one of the plurality of laminate batteries fails to function, a problem may occur. Particularly, when the plurality of laminate batteries are all connected in series, the power supply device itself cannot be used. In such a case, maintenance of the power supply device is necessary.

However, in the power supply device described in Patent Literature 1, since the casing is made of a metallic material, the number of components for insulating each laminate battery from the casing is large. As a result, work of attaching/detaching the laminate battery to/from the casing is complex, necessitating much time and labor for maintenance.

It is therefore an object of the present invention to provide a battery unit in which maintenance of laminate batteries can be easily performed and to provide a power supply device that includes the battery unit.

### Solution to Problem

To achieve the object, a battery unit according to the present invention includes: a plurality of laminate batteries electrically connected with each other; and a tray on which the plurality of laminate batteries is mounted and which is stackable on another tray on which another plurality of laminate batteries is mounted. On the respective outer peripheral portions of the plurality of laminate batteries, there are formed pressure releasing sections that respectively release pressure generated in the plurality of laminate batteries to the outside. The plurality of laminate batteries is disposed such that pressure releasing sections are adjacent to the outer peripheral portion of the tray.

### Effects of Invention

According to the present invention, maintenance of the laminate batteries mounted on the tray can be easily carried out.

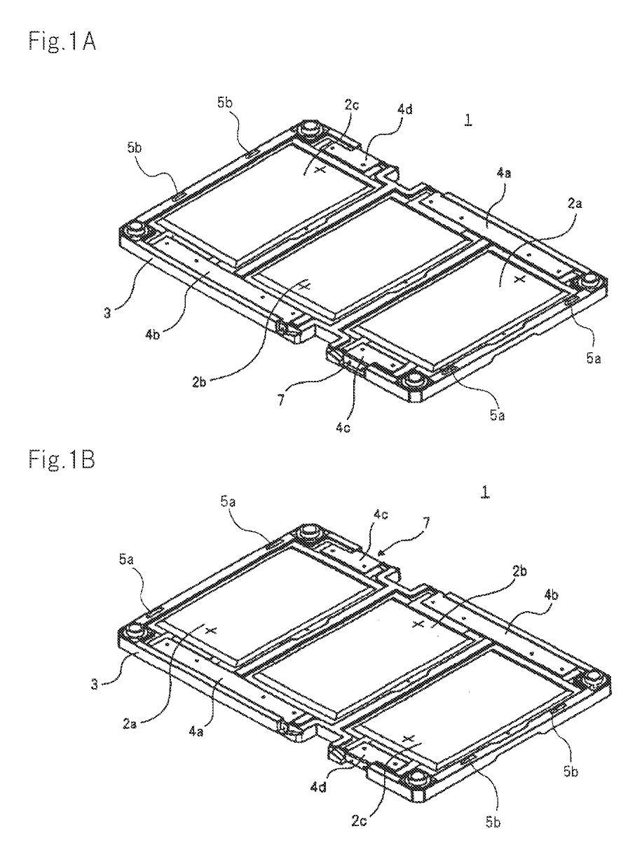

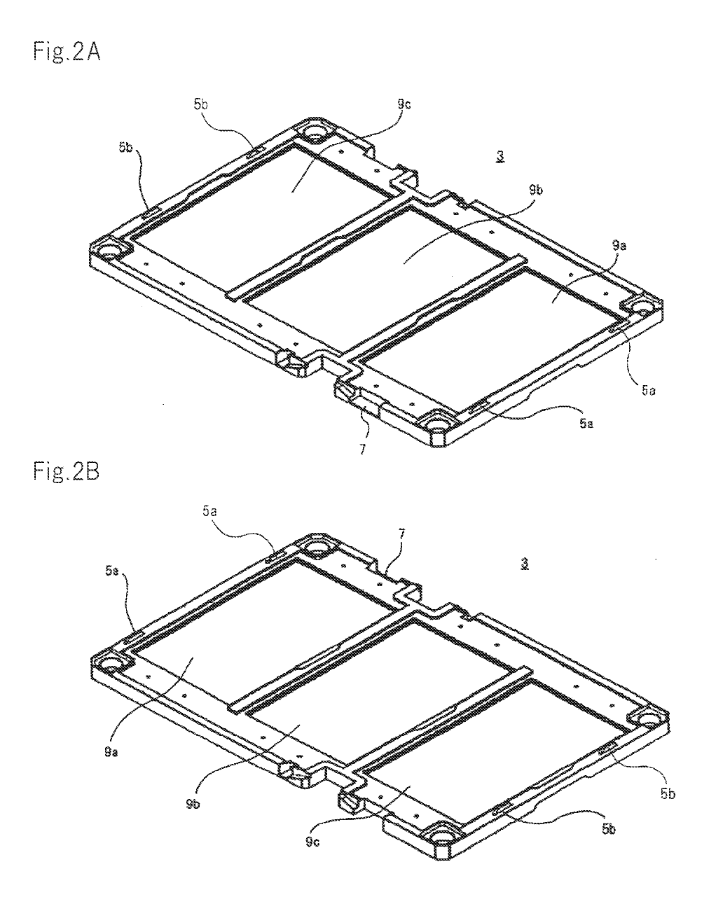

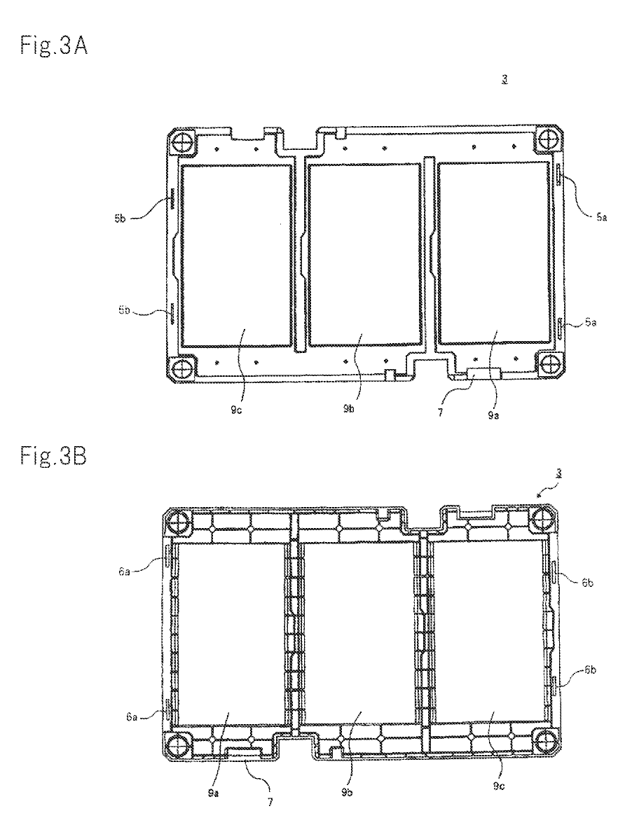

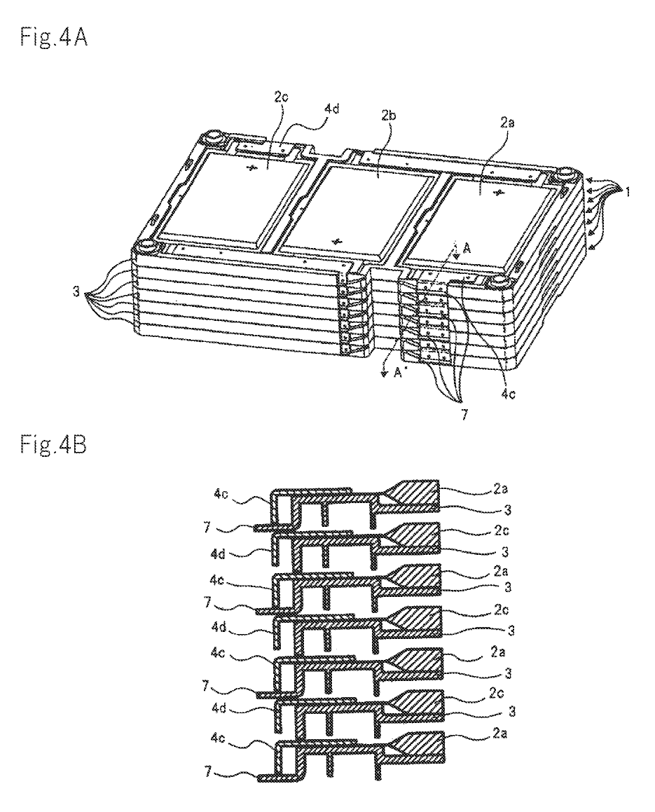

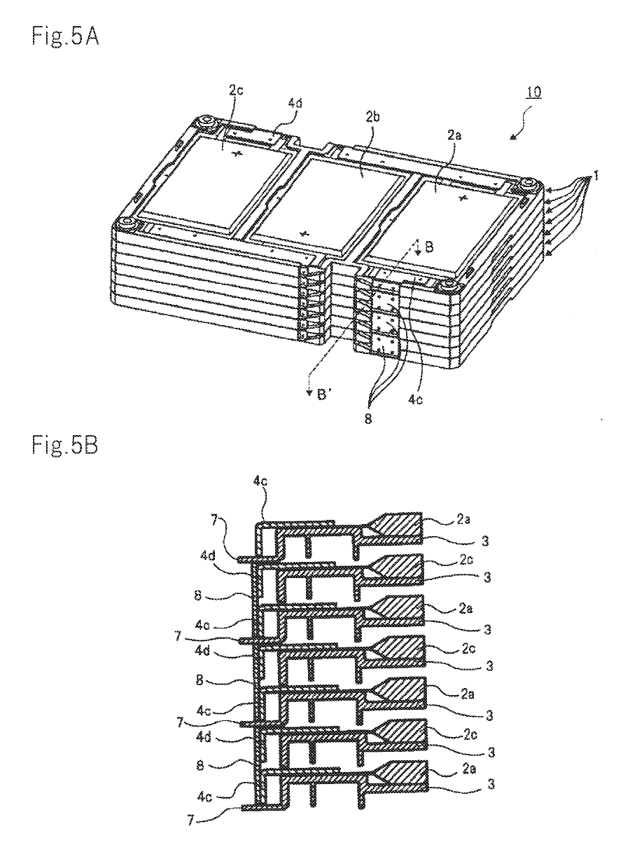

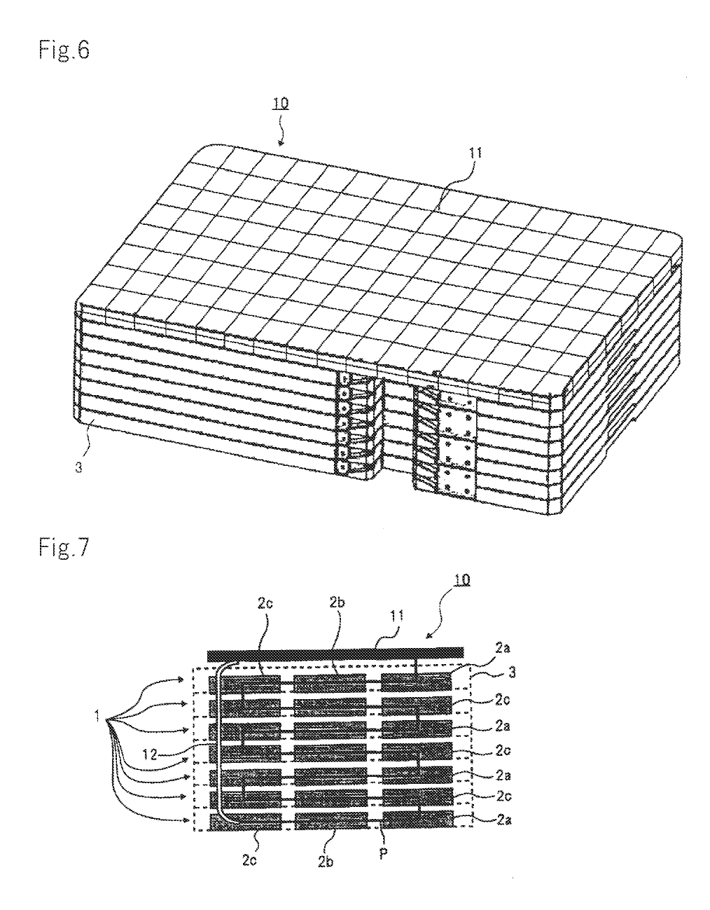

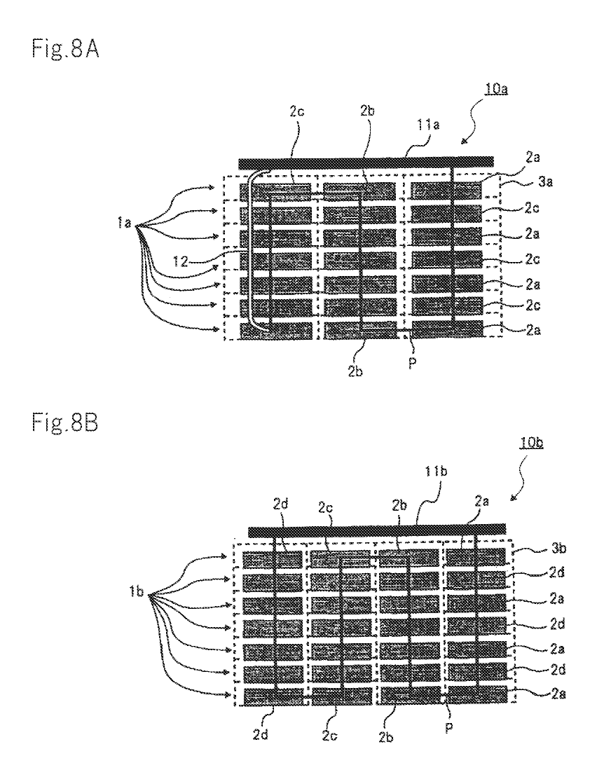

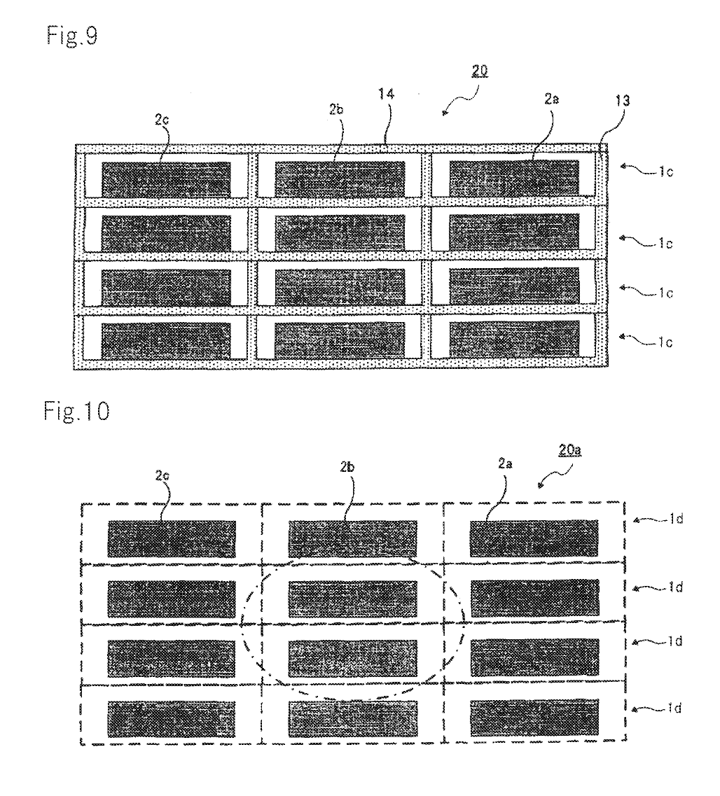

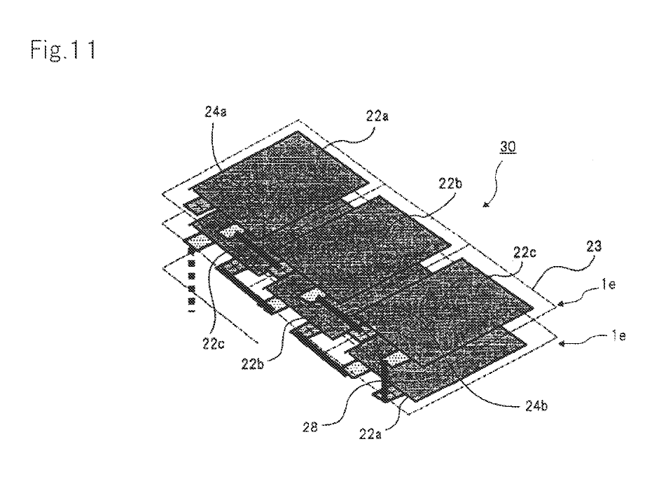

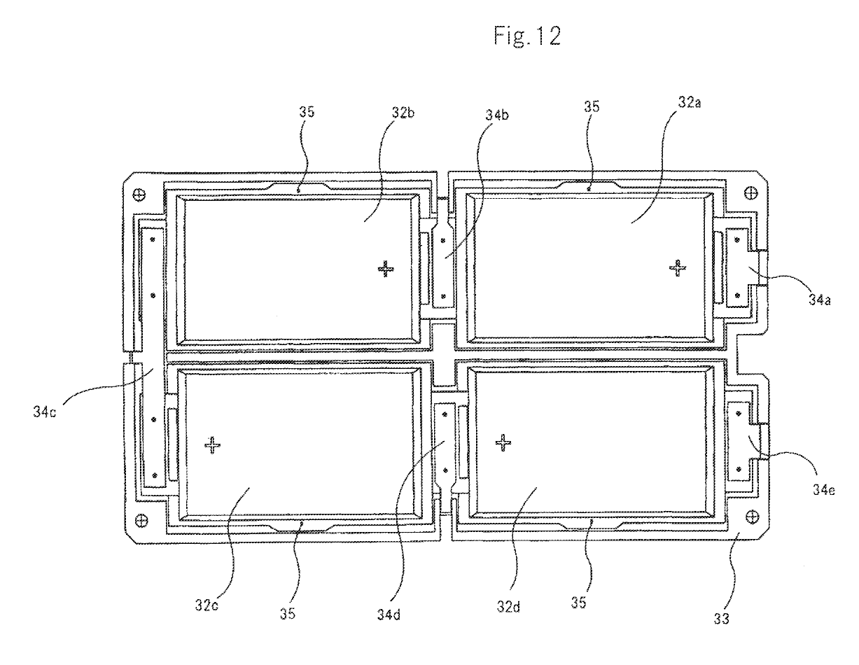

### BRIEF DESCRIPTION OF DRAWINGS

[FIG. 1A] A perspective view showing a battery unit according to a first embodiment.

[FIG. 1B] A perspective view showing the battery unit shown in FIG. 1A.

[FIG. 2A] A perspective view showing a tray shown in FIG. 1A.

[FIG. 2B] A perspective view showing the tray shown in FIG. 1A.

[FIG. 3A] A top view showing the tray shown in FIG. 1A.

[FIG. 3B] A bottom view showing the tray shown in FIG. 1A.

[FIG. 4A] A perspective view showing the laminated state of the battery unit shown in FIG. 1A.

[FIG. 4B] A sectional view cut along the line A-A′ shown in FIG. 4A.

[FIG. 5A] A perspective view showing a power supply device according to the first embodiment.

[FIG. 5B] A sectional view cut along the line B-B′ shown in FIG. 5A.

[FIG. 6] A perspective view showing the power supply device according to the first embodiment.

[FIG. 7] A schematic view showing the ion conduction path of the power supply device shown in FIG. 5A.

[FIG. 8A] A schematic view showing the connection path of laminate batteries as a modified example of the power supply device shown in FIG. 7.

[FIG. 8B] A schematic view showing the connection path of the laminate batteries as the modified example of the power supply device shown in FIG. 7.

[FIG. 9] A side sectional view showing a power supply device according to a second embodiment.

[FIG. 10] A side sectional view showing a comparative example of the power supply device shown in FIG. 9.

[FIG. 11] A perspective view showing a power supply device according to a third embodiment.

[FIG. 12] A plan view showing a battery unit according to a fourth embodiment.

### DESCRIPTION OF EMBODIMENTS

Hereinafter, the embodiments of the present invention will be described with reference to the accompanying drawings.

### First Embodiment

FIGS. 1A and 1B are perspective views showing battery unit 1 according to a first embodiment when seen from above. FIG. 1B shows battery unit 1 from a side of a horizontal direction opposite that shown in FIG. 1A.

Battery unit 1 according to this embodiment includes three flat-plate laminate batteries 2a to 2c, and tray 3 to which laminate batteries 2a to 2c are attached.

In this embodiment, lithium ion secondary batteries are used as laminate batteries 2a to 2c. However, the laminate batteries are not limited to the lithium ion secondary batteries. Other laminate batteries such as nickel hydride batteries can be used.

Three laminate batteries 2a to 2c are arrayed in tray 3 so that positive electrodes and negative electrodes can be opposite each other. In other words, the positive electrode and the negative electrode of laminate batteries 1a and 1c are in the same direction, while the positive electrode and the negative electrode of laminate battery 1b disposed between laminate batteries 1a and 1c are opposite those of laminate batteries 1a and 1c in direction.

The positive electrode of laminate battery 1a and the negative electrode of laminate battery 1b are electrically connected to each other via bus bar 4a, and the positive electrode of laminate battery 2b and the negative electrode of laminate battery 2c are electrically connected to each other via bus bar 4b. Laminate batteries 2a to 2c are accordingly connected in series. Bus bar 4c is disposed in the negative electrode of laminate 1a, and bus bar 4d is disposed in the positive electrode of laminate 1c. In other words, bus bar 4c is a positive electrode terminal of battery unit 1, and bus bar 4d is a negative electrode terminal of battery unit 1.

Bus bars 4a to 4d are made of copper or copper compounds relatively high in electric conductivity and relatively low in price. However, it is desirable for bus bars 4a to 4d to be made of materials high in electric conductivity, such as silver or silver compounds. Bus bars 4a to 4d can be made of inexpensive iron to reduce manufacturing costs.

Bus bars 4a to 4d are fixed to tray 3 by screws sandwiching the positive electrodes and the negative electrodes of laminate batteries 2a to 2c. Accordingly, respective bus bars 4a to 4d are electrically connected to the positive electrodes and the negative electrodes of laminate batteries 2a to 2c, and laminate batteries 2a to 2c are mechanically fixed to tray 3.

Laminate batteries 2a to 2c can therefore be removed from tray 3 by removing bus bars 4a to 4d, and can be conversely attached to tray 3 by bus bars 4a to 4d. Thus, laminate batteries 2a to 2c can be easily attached or detached by bus bars 4a to 4d. In other words, in battery unit 1 according to this embodiment, the number of components for attaching or detaching laminate batteries 2a to 2c is small.

FIGS. 2A and 2B are perspective views showing tray 3 seen from above. Referring to FIGS. 2A and 2B, tray 3 will be described in detail.

Tray 3 is made of a material having heat resistance and insulation properties. Tray 3 according to this embodiment is made of a polycarbonate resin. However, as a material of tray 3, any material such as polypropylene ethylene, nylon, or PET (polyethylene terephthalate) can be used as long as it has insulation properties.

Tray 3 includes stacking section 9a on which laminate battery 2a is mounted, stacking section 9b on which laminate battery 2b is mounted, and stacking section 9c on which laminate battery 2c is mounted. Stacking sections 9a to 9c are formed into concave shapes to house laminate batteries 2a to 2c. At the end of tray 3 on stacking section 9a side, two projections 5a are formed to project upward. At the end on stacking section 9c side, two projections 5b are formed to project upward. Projections 5a are formed at an interval wider than that of projections 5b.

Tray 3 has insulation properties. This eliminates the necessity of a component for insulating laminate batteries 2a to 2c, stacked on stacking sections 9a to 9c of tray 3, from one another. As a result, battery unit 1 according to this embodiment can be realized with a simple configuration by reducing the number of components.

FIG. 3A is a top view of tray 3, and FIG. 3B is a bottom view of tray 3. As shown in FIG. 3B, holes 6a corresponding to projections 5a and holes 6b corresponding to projections 5b are formed on the rear surface of tray 3. Tray 3 can be configured in a normal laminated state by stacking, on the top surface of battery unit 1, the rear surface of another battery unit 1 different from this battery unit 1 so that two projections 5a can be fitted into holes 6a and two projections 5b can be fitted into holes 6b.

In other words, tray 3 can be stacked on another tray 3 by rotating tray 3 by 180° around a central axis orthogonal to the top surface and the bottom surface with respect to said another tray 3, which is different from tray 3.

Projections 5a and 5b and holes 6a and 6b are fitted to each other in the stacked state of trays 3, thereby functioning as regulation sections to regulate movement in a direction different from the stacking direction of tray 3. Even when many trays 3 are stacked, this prevents the positional shifting of each tray 3 or prevents stacked trays 3 from falling apart.

In the stacked state of trays 3, trays 3 adjacent to each other in the stacking direction have ends on stacking section 9a side set opposite each other. Specifically, in the stacked state of trays 3, in trays 3 adjacent to each other in the stacking direction, stacking sections 9a and 9b are adjacent to each other in the stacking direction, and stacking section 9b follows in the stacking direction. Supposing that trays 3 adjacent to each other in the stacking direction are stacked in the same direction, projections 5a and holes 6a are not fitted to each other. Consequently, a normal stacked state is not realized.

Trays 3 can be stacked on each other even when laminate batteries 2a to 2c are attached to trays 3 by bus bars 4a to 4d. In other words, battery units 1 can be stacked on each other.

FIG. 4A is a perspective view showing seven stacked battery units 1 according to this embodiment. FIG. 4B is a sectional view cut along the line A-A′ shown in FIG. 4A. As shown in FIG. 4B, in the stacked state of battery units 1, laminate batteries 2a and laminate batteries 2c are alternately arranged in the stacking direction of trays 3.

In battery unit 1 according to this embodiment, when battery unit 1 is rotated by 180° around the central axis orthogonal to the top surface and the bottom surface, bus bar 4c that is a positive electrode and bus bar 4d that is a negative electrode are reversed. Accordingly, as shown in FIG. 4A, in battery units 1 adjacent to each other, bus bar 4c and bus bar 4d are adjacent to each other.

As shown in FIGS. 1A to 3B, insulation section 7 is formed in tray 3. Insulation section 7 is made of the same material as that of tray 3, and disposed adjacently to the lower side of the attaching position of bus bar 4c in tray 3. On the other hand, no insulation section 7 is disposed below the attaching position of bus bar 4d in tray 3.

As shown in FIG. 4B, insulation section 7 is formed between bus bar 4c and bus bar 4d located adjacently to the lower side of bus bar 4c. Insulation section 7 having insulation properties serves to prevent electric connection of bus bar 4c with bus bar 4d located adjacently to the lower side of bus bar 4c. On the other hand, insulation section 7 is not formed between bus bar 4c and bus bar 4d located adjacently to the upper side of bus bar 4c. When seen from a side opposite that shown in FIG. 4A, in other words, when seen from bus bar 4d side of uppermost battery unit 1, similarly, insulation section 7 is formed between bus bar 4d and bus bar 4c located adjacently to the lower side of bus bar 4d, while insulation section 7 is not formed between bus bar 4d and bus bar 4c located adjacently to the upper side of bus bar 4d.

FIG. 5A is a perspective view showing power supply device 10 configured by stacking seven battery units 1 according to this embodiment. FIG. 5B is a sectional view cut along the line B-B′ shown in FIG. 5A. Power supply device 10 is configured by electrically connecting battery units 1 shown in FIG. 5A by connection members 8. Connection member 8 is fixed to bus bar 4d and bus bar 4c located adjacently to the lower side of bus bar 4d by screws. Accordingly, bus bar 4d and bus bar 4c located adjacently to the lower side of bus bar 4d are electrically and mechanically connected to each other.

In power supply device 10, as described above, bus bar 4c as the negative electrode and bus bar 4d as the negative electrode of battery units 1 adjacent to each other are located adjacently to each other. Thus, battery units 1 adjacent to each other can be easily connected together by connection members 8.

In this embodiment, battery unit 1 includes three laminate batteries 2a to 2c connected in series. However, there only need to be an odd number of laminate batteries included in battery unit 1. This is because as long as the number of laminate batteries included in battery unit 1 is odd, when tray 3 is rotated by 180° around the central axis orthogonal to the top surface and the bottom surface, the bus bar as the positive electrode and the bus bar as the negative electrode are reversed. On the other hand, in the case of an even number of laminate batteries included in the battery unit, even when tray 3 is rotated by 180° around the central axis orthogonal to the top surface and the bottom surface, the bus bar as the positive electrode and the bus bar as the negative electrode are not reversed.

As in the case of bus bars 4a to 4d, connection members 8 are made of copper or copper compounds that have relatively high electrical conductivity and that are relatively low in price. However, it is desirable for connection members 8 to be made of materials that have high electrical conductivity, such as silver or silver compounds. Connection members 8 can be made of inexpensive iron to reduce manufacturing costs.

Insulation section 7 can be formed adjacently to the lower side of the attaching position of bus bar 4d in tray 3. In this case, insulation section 7 is not formed below the attaching position of bus bar 4c in tray 3. Connection member 8 is fixed to bus bar 4c and bus bar 4d located adjacently to the lower side of bus bar 4c by screws.

As shown in FIG. 5A, seven battery units 1 adjacent to each other in the vertical direction of power supply device 10 are electrically interconnected by connection members 8 to be connected in series. In other words, in power supply device 1, since three laminate batteries 2a to 2c of each battery unit 1 are connected in series, totally twenty one laminate batteries are connected in series. In power supply device 10, bus bar 4d of lowermost battery unit 1 is a positive electrode terminal, while bus part 4c of uppermost battery unit 1 is a negative electrode terminal.

To safely operate the lithium ion battery, power supply device 10 shown in FIG. 5A must include a control board for controlling output power from the plurality of battery units 1 and for preventing excessive charging or excessive discharging. FIG. 6 is a perspective view showing power supply device 10 having control board 11 mounted on its uppermost part. Control board 11, which has the same outer shape as that of battery unit 1, is formed so as not to greatly project in a direction different from the stacking direction of battery units 1 when mounted on battery unit 1. In control board 11, bus bar 4d of lowermost battery unit 1 that is the positive electrode terminal of power supply device 10 and bus bar 4c of uppermost battery unit 1 that is the negative electrode terminal of power supply device 10 are electrically connected. Control board 11 includes an electric circuit (not shown) or the like, and enables safe inputting or outputting of power from power supply device 10.

In power supply device 10, an output voltage can be easily changed by changing the number of battery units 1 to be stacked. Specifically, in power supply device 10, when the number of battery units 1 to be stacked is increased, the output voltage of power supply device 10 rises. When the number of battery units 1 to be stacked is decreased, the output voltage of power supply device 10 drops.

Further, the insulating material such as a polycarbonate resin for tray 3 of battery unit 1 is relatively light. Thus, even when many battery units 1 are stacked, the load on tray 3 of battery unit 1 of the lower side is limited to be small, thereby preventing easy damaging of battery unit 1 of the lower side. This enables stacking of many battery units 1 in power supply device 10.

Battery units 1 vertically adjacent to each other can be removed by detaching connection members 8 from bus bars 4c and 4d. Thus, in power supply device 10 according to this embodiment, even when a problem occurs in one of the plurality of battery units 1, battery unit 1 can be removed to be easily replaced with new battery unit 1.

As described above, three laminate batteries 2a to 2c included in battery unit 1 are detachable, and accordingly only one or more arbitrary failed laminate batteries 2 from among three laminate batteries 2a to 2c can be replaced. Thus, in power supply device 10, when one of the plurality of battery units fails, without preparing any new battery unit 1, only one or more arbitrary failed laminate batteries 2 in battery unit 1 removed from power supply device 10 is replaced and then returned to the same position of power supply unit 10. As a result, power supply device 10 can be repaired.

Thus, in the power supply device according to this embodiment, the maintenance of laminate batteries 2 of arbitrary battery unit 1 is easy.

FIG. 7 is a schematic view showing the ion conduction path P of power supply device 10 shown in FIG. 6. Bus bar 4d of lowermost battery unit 1 that is positive electrode terminal 1 is connected to control board 11 via lead wire 12, while bus bar 4c of uppermost battery unit 1 that is negative electrode terminal 1 is electrically and directly connected to control board 11.

As a modified example of this embodiment, by changing the shapes or the arrangement of the bus bars and the connection members, the connection path P of the laminate batteries can be changed as in the case of power supply device 10a shown in FIG. 8A. As in the aforementioned case, all laminate batteries 2a to 2c in power supply device 10a are connected in series, and an output voltage equal to that of power supply device 10 shown in FIG. 7 can be acquired. In power supply device 10a, bus bar 4d of lowermost battery unit 1a is a positive electrode terminal, while bus part 4c of uppermost battery unit la is a negative electrode terminal.

As a modified example of this embodiment, by changing the tray configuration, the number of laminate batteries mounted in the tray of one battery unit can appropriately be changed. Thus, the total capacity of one battery unit can be easily changed.

FIG. 8B shows power supply device 10b where the number of laminate batteries mounted in the tray of one battery unit is changed. Each tray 3b of power supply device 10b shown in FIG. 8B includes four laminate batteries 2a to 2d. In power supply device 10b, bus bar 4d of uppermost battery unit 1b is a positive electrode terminal, while connection member bus part 4c of uppermost battery unit 1b is a negative electrode terminal. Accordingly, even without lead wires 12 of power supply devices 10 and 10a shown in FIGS. 7 and 8A, the positive electrode terminal and the negative electrode terminal can be electrically and directly connected to control board 11. As a result, internal resistance in the power supply device can be reduced, and manufacturing steps and costs can be reduced. FIG. 8B shows the case where the number of laminate batteries in each battery unit 1b is four. However, the number of laminate batteries is not limited to four. The same effects as those of the embodiment can be provided as long as the number of laminate batteries is even.

In the power supply device according to this embodiment, all the laminate batteries of each battery unit are connected in series. Needless to say, however, in the power supply device, all the laminate batteries can be connected in parallel by changing the configuration of the tray and by appropriately changing the configuration of the bus bars or the connection members according to the configuration of the tray, or some laminate batteries can be connected in series while the other laminate batteries can be connected in parallel.

In the power supply device according to this embodiment, laminate batteries are used. Needless to say, however, batteries are not limited to the laminate batteries. Any type of battery can be used as long as it is a flat-plate battery.

### Second Embodiment

FIG. 9 is a side sectional view showing power supply device 20 according to a second embodiment. Power supply device 20 is configured by stacking four battery units 1c. Power supply device 20 according to the second embodiment is similar in configuration to power supply device 10 according to the first embodiment except for the following components.

Tray 13 of battery unit 1c according to this embodiment includes partition walls to respectively surround the outer peripheral portions of laminate batteries 2a to 2c. Battery units 1c are stacked, and tray 13 and the lower surface of tray 13 adjacent to the upper surface of this tray 13 form individual chambers to respectively cover laminate batteries 1a to 1c. Only uppermost battery unit 1c does not include tray 13 adjacent to the upper surface of tray 13. Cap 14 made of the same material as that of tray 13 is disposed on uppermost battery unit 1c. Cap 14 can be substituted for control board 11 shown in FIG. 6.

As described above in the first embodiment, tray 13 is made of a material having low heat conductivity. Thus, it is difficult for heat generated by laminate batteries 2a to 2c be released from the inside of tray 13 to the outside.

FIG. 10 is a side sectional view showing a power supply device according to a comparative example. Power supply device 20a according to the comparative example is configured by stacking four battery units 1d. In power supply device 20a, different from power supply device 20 shown in FIG. 9, laminate batteries 2a to 2c are not covered with tray 13. Thus, heat generated by laminate batteries 2a to 2c is easily diffused to the environment. This causes, in power supply device 20a according to the comparative example, a high temperature to occur in the center region surrounded with a chain line to which heat is easily added from the surrounding laminate batteries. As a result, in power supply device 20a, temperature environments are nonuniform in the laminate battery disposed in the center region and the laminate battery disposed in the outer peripheral portion, creating a high possibility of a problem in the power supply source.

On the other hand, in power supply device 20 shown in FIG. 9, the heat generated from laminate batteries 2a to 2c easily stays in each individual chamber of tray 13. Accordingly, temperatures are almost constant in any of the individual chambers of tray 13. In other words, an ambient temperature distribution is difficult to be generated among laminate batteries 2a to 2c. As a result, in power supply device 20 according to this embodiment, it s difficult for problems to occur in laminate batteries 2a to 2c.

Further, when a thermal runaway occurs in one laminate battery, there is a possibility that the thermal runaway will lead to an induced explosion, that is, due to the heat that is generated from one laminate battery, the phenomenon of thermal runaway will occur in adjacent laminate batteries, from one laminate battery after another laminate battery. On the other hand, in power supply device 20 shown in FIG. 9, it is difficult for heat to be conducted to the outside of each individual chamber. Thus, even when thermal runaway occurs in one laminate battery, the occurrence of induced explosion can be prevented.

### Third Embodiment

FIG. 11 is a perspective view showing power supply device 30 according to a third embodiment. Power supply device 30 is configured by stacking a plurality of battery units 1e. Power supply device 30 according to this embodiment is similar in configuration to power supply device 10 according to the first embodiment except for the components described below. For convenience, tray 23 of each battery unit 1e is indicated by a broken line.

In each battery unit 1e of power supply device 30 according to this embodiment, the positive electrodes and the negative electrodes of laminate batteries 22a to 22c are pulled out in the same direction. In power supply device 30, the negative electrode of laminate battery 22a and the positive electrode of laminate battery 22b are electrically connected to each other via bus bar 24a, and the negative electrode of laminate battery 22b and the positive electrode of laminate battery 22c are electrically connected to each other via bus bar 24b. Laminate batteries 22a to 22c are accordingly connected in series. Further, the negative electrode of laminate battery 22c is electrically connected to the positive electrode of laminate battery 22a of battery unit 1e adjacent to the lower side of this battery unit 1e.

Thus, in power supply device 30, laminate batteries 22a to 22c of each battery unit 1e are connected in series, and further battery units 1e are connected in series. In power supply device 30, therefore, the positive electrode of laminate battery 22a of uppermost battery unit 1e is a positive electrode terminal, while the negative electrode of laminate battery 22c of lowermost battery unit 1e is a negative electrode terminal.

### Fourth Embodiment

A power supply device according to a fourth embodiment is configured by stacking a plurality of battery units. The power supply device is similar in configuration to power supply device 10 according to the first embodiment except for the following components. Thus, in the fourth embodiment, only the battery units will be described. FIG. 12 is a plan view showing the battery units according to the fourth embodiment.

The battery unit according to the fourth embodiment is characterized by the state in which laminate batteries are mounted in a tray.

As shown in FIG. 12, the battery unit according to the fourth embodiment includes a plurality of laminate batteries 32 (32a to 32d), tray 33 on which the plurality of laminate batteries 32 is mounted, and a plurality of bus bars 34a to 34e for electrically connecting the plurality of laminate batteries 32. As in the case of the aforementioned embodiments, tray 33 can be stacked on another tray 33 on which a plurality of laminate batteries 32 is mounted.

As shown in FIG. 13, battery unit 32 according to this embodiment further includes gas discharge section 35 in its outer peripheral portion, which serves as a pressure releasing section for releasing pressure generated in laminate battery 32 to the outside. Gas discharge section 35 has a discharge hole formed in the welded part of the outer peripheral portion of a laminate film constituting laminate battery 32. When predetermined pressure is applied from the inside of laminate battery 32, the laminate film is broken off from the discharge hole. The formation of gas discharge section 35 enables releasing, when the internal pressure of laminate battery 32 abnormally rises, the high-pressure gas in laminate battery 32 from gas discharge unit 35 to the outside.

When a plurality of laminate batteries including such gas discharge sections is located in one tray, it is desirable not to dispose any other laminate battery in a position where gas is released from the gas discharge section of the laminate battery. When another laminate battery is disposed in a position adjacent to the gas discharge section of the laminate battery, other adjacent laminate batteries are heated one after another by heat released from the gas discharge section causing releasing of gas from the gas discharge section of another laminate battery. This may cause a phenomenon of induced explosion.

Accordingly, in tray 33 of the battery unit according to this embodiment, as shown in FIG. 12, the plurality of laminate batteries 32 is disposed so that respective gas discharge sections 35 of the plurality of laminate batteries 32 can be adjacent to the outer peripheral portion of tray 33. The plurality of laminate batteries 32a to 32d according to this embodiment are connected in series by bus bars 34a to 34e. This arrangement of the plurality of laminate batteries 32 can prevent induced explosion of another laminate battery 32 caused by heat of the gas released from gas discharge section 35.

Though not shown, in tray 33, for example, a cooling structure such as a heat sink can be formed near gas discharge section 35 of laminate battery 32. Tray 33 heated by the gas released from laminate battery 32 can be cooled by the cooling structure. Further, in tray 33, a sheet material for absorbing liquid leaked from gas discharge section 35 can be disposed near gas discharge section 35 of laminate battery 32.

As described above, according to the battery unit constituting the power supply device of the fourth embodiment, when high-pressure gas is released from gas discharge section 35 of arbitrary laminate battery 32, heating of another laminate battery 32 by heat of this high-pressure gas can be prevented. As a result, according to this embodiment, by arranging respective gas discharge sections 35 of the plurality of laminate batteries 32 adjacently to the outer peripheral portion of tray 33, safety of the battery unit and the power supply device can be improved.

In the fourth embodiment, as the laminate battery, the laminate battery configured by disposing the gas discharge section in the center of the outer peripheral portion in a longitudinal direction is used. However, when necessary, a laminate battery configured by disposing a gas discharge section, for example, in the center of the outer peripheral portion in a short-side direction can be used. In this case, for example, it is desirable to arrange a plurality of laminate batteries so that they can be adjacent to each other in a longitudinal direction, and to arrange the plurality of laminate batteries so that the gas discharge sections of the laminate batteries adjacent to each other can respectively be adjacent to a pair of outer peripheral portions of the tray that are opposite to each other.

In the fourth embodiment, four laminate batteries 32 are arranged. Needless to say, however, the laminate batteries are not limited to this arrangement, nor is the number of laminate batteries limited to an even number. Changes can appropriately be made to the arrangement when necessary.

The embodiments of the present invention have been described. However, the present invention is not limited to the embodiments. Various changes understandable to those skilled in the art can be made to the configuration and the specifics of the present invention without departing from the spirit and the scope of the invention.

This application claims priority from Japanese Patent Application No. 2010-115234 filed May 19, 2010, which is hereby incorporated by reference herein in its entirety.

### REFERENCE NUMERALS

1 Battery unit

10 Power supply device

32 (32a, 32b, 32c, and 32d): Laminate battery

33 Tray

34a, 34b, 34c, 34d, and 34e Bus bar

35 Gas discharge section

1. A battery unit comprising:
a plurality of laminate batteries electrically connected with each other; and
a tray on which the plurality of laminate batteries is mounted and which is stackable on another tray on which another plurality of laminate batteries is mounted,
wherein:
on respective outer peripheral portions of the plurality of laminate batteries, pressure releasing sections that respectively release pressure generated in the plurality of laminate batteries to the outside is formed; and
the plurality of laminate batteries is disposed such that pressure releasing sections are adjacent to the outer peripheral portion of the tray.

2. The battery unit according to claim 1, further comprising a regulation section that regulates movement of the tray in a direction different from a stacking direction of the trays in the stacked state of the tray on the another tray.

3. The battery unit according to claim 1, wherein positive electrodes and negative electrodes of the plurality of laminate batteries are adjacent to each other in the stacking direction of the trays in the stacked state of the tray on the another tray.

4. The battery unit according to claim 1, wherein:
the plurality of laminate batteries is connected in series; and
a positive electrode terminal and a negative electrode terminal connected to both ends of the serial connection are arranged, and the positive electrode terminal and the negative electrode terminal are adjacent to each other in the stacking direction of the trays in the stacked state of the tray on the another tray.

5. The battery unit according to claim 4, further comprising an insulation section formed adjacently to one of the positive electrode terminal and the negative electrode terminal and configured to separate the positive electrode terminal and the negative electrode terminal adjacent to each other in the stacking direction from each other in the stacked state of the tray on the another tray.

6. A power supply device comprising:
the plurality of battery units according to claim 1; and
a connection member for electrically connecting the battery units adjacent to each other in the stacking direction of the plurality of stacked trays.

7. A power supply device comprising:
the plurality of battery units according to claim 4; and
a connection member for electrically connecting the battery units in series in the stacking direction by connecting the positive electrode terminal and the negative electrode terminal adjacent to each other in the stacking direction.

8. The power supply device according to claim 6, further comprising a control board configured to be stackable on the tray and to control output power from the plurality of battery units.
